(19) United States
(12) Patent Application Publication
(10) Pub. No.: US 2008/0184108 A1
(43) Pub. Date: Jul. 31, 2008

(54) EDITING AND PRINTING SYSTEM, EDITING SYSTEM, METHOD AND COMPUTER-READABLE MEDIUM

(75) Inventors: Takahide Inoue, Kanagawa (JP); Takeshi Morimoto, Tokyo (JP); Shoichi Goto, Tokyo (JP); Tokuya Kameshima, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/780,700

(22) Filed: Jul. 20, 2007

(30) Foreign Application Priority Data
Jan. 25, 2007 (JP) 200715541

(51) Int. Cl. G06F 15/00; G06F 17/28; G06F 17/27; G06F 17/26

(52) U.S. Cl. 715/243; 715/251; 715/229

(57) ABSTRACT

There is provided an editing and printing system, including: a layout information memory that stores layout information including information on a layout area for each original article on a page and information indicating whether or not each original article is replaceable; a replacement candidate memory that stores replacement candidate articles; a replaced version generation unit that generates a page of a replaced version by arranging a replacement candidate article stored in the replacement candidate memory in the layout area for an original article which is defined as replaceable in the layout information; and a printing unit that prints the page of the replaced version generated by the replaced version generation unit.

### CROSS-REFERENCE TO RELATED APPLICATIONS

This application is based on and claims priority under 35 USC 119 from Japanese Patent Application No. 2007-015541 filed on Jan. 25, 2007.

### BACKGROUND

1. Technical Field

The present invention relates to an editing system, an editing and printing system, a method for producing a printed material and a computer-readable medium.

2. Related Art

In recent years, production of printed materials such as newspapers has been increasingly automated. In production of a newspaper, data on newspaper pages which are edited at the head office or a branch office may be transmitted to a printing office, which then prints the data. Composition systems for supporting layout of articles are also known. When a user operates a composition system to design the layout of articles, photographs, and/or graphics, the system outputs layout data representing the layout. On the basis of layout data, the composition system composes article or photograph data to generate data on newspaper pages.

### SUMMARY

According to a first aspect of the invention, there is provided an editing and printing system including: a layout information memory that stores layout information including information on a layout area for each original article on a page and information indicating whether or not each original article is replaceable; a replacement candidate memory that stores replacement candidate articles; a replaced version generation unit that generates a page of a replaced version by arranging a replacement candidate article stored in the replacement candidate memory in the layout area for an original article which is defined as replaceable in the layout information; and a printing unit that prints the page of the replaced version generated by the replaced version generation unit.

### BRIEF DESCRIPTION OF THE DRAWINGS

An exemplary embodiment of the present invention will be described in detail by reference to the following figures, wherein:

FIG. 1 shows an exemplary system configuration of an exemplary embodiment;

FIG. 2 shows an example of article data;

FIG. 3 shows an example of layout data;

FIG. 4 is a flowchart showing an example of the processing procedure of a replacement processing unit;

FIG. 5 illustrates a relocatable area in a page;

FIG. 6 illustrates priority among partial areas in a page space;

FIG. 7 shows an exemplary system configuration of a variation; and

FIG. 8 shows an exemplary hardware configuration of a computer.

### DETAILED DESCRIPTION

An exemplary embodiment will be described by, illustrating a system for producing a newspaper, a typical printed material. However, as will be apparent from the following description, the system of this exemplary embodiment is also applicable to production of other printed materials.

The newspaper production system of this exemplary embodiment includes a head office system 10 and a branch office system 20. The head office system 10 is a system for newspaper editing which is provided in the head office of a newspaper company. Editors or the like at the head office use the system to edit newspapers. Newspaper page data produced from editing include data on articles to be laid out on newspaper pages and data indicating the layout of the articles. Hereinafter, an article laid out in a pages space as a result of editing on the head office system 10 will be called an original article. Newspaper page data generated by the head office system 10 include data on one or more original articles 50 and layout data 52 which define layout on each page.

FIG. 2 shows an example of article data. The article data of this example are written in eXtensible Markup Language (XML). In this example, an “Item” element represents one article. A “Type” element in the “Item” element represents the formal type of the article, such as text, a photographic image, or a graphic. A “Category” element represents a category of the contents of the article. The category information can be used for determining in which section; e.g., general news, life, and sports sections, the article should be laid out. A “Priority” element represents the priority assigned to the article. The priority may be represented by a positive integer value, in which case the higher the priority, the greater the value. A “Date” element represents the expiration date of the article. The article will become invalid after this date. Alternatively, it is possible to include an element representing the starting and ending dates of a validity period instead of such an element representing an expiration date. A “Font” element specifies a font for use for the text character strings of the article. When the type of the article is text, a font can be specified with this element. A “CharCount” element represents the number of text characters in the article, and is included in article data when the article of interest assumes the form of text. A “Content” element represents the contents of the article. For example, when the type of the article is text, text character strings are contained in this element.

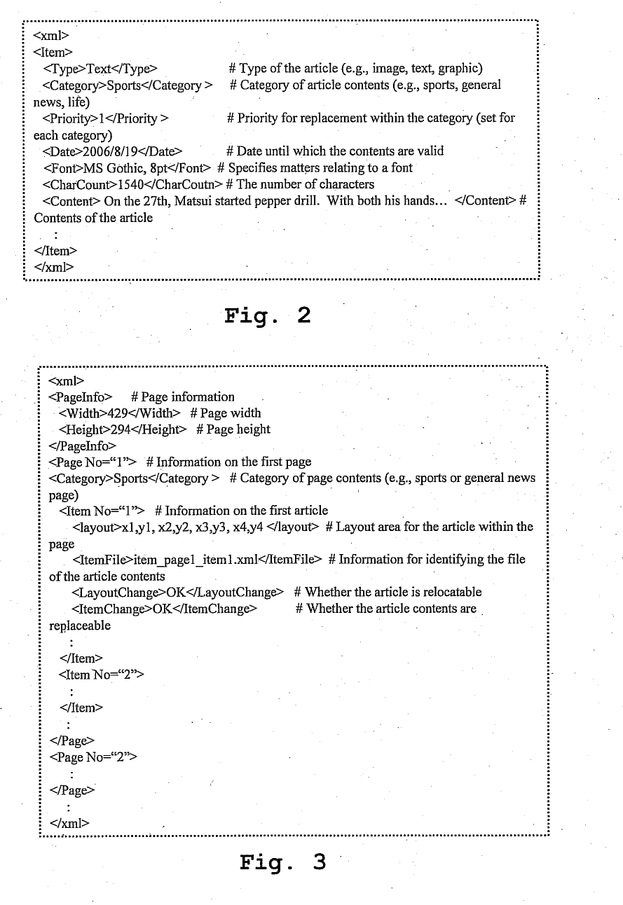

FIG. 3 shows an example of layout data. In this example, the layout data are written in XML. A “PageInfo” element is information that defines a newspaper page. In this example, the width and height of the page are described in this element. The element is followed by “Page” elements that define individual pages constituting the newspaper. A “No” attribute in the tag of the “Page” element represents a page number. A “Category” element in the “Page” element represents the category of the page in terms of contents. The category may include general news and sports pages. An “Item” element defines one article to be laid out on the page. A “No” attribute in the tag of the “Item” element represents the identification number of the article within the page. The “Page” element contains zero or more “Item” elements.

A “layout” element in the “Item” element represents the position and shape of the area in which the article should be laid out on the page. In this element, vector data or the like representing the outer shape of the layout area for the article may be described. An “ItemFile” element contains information for identifying the data file for the article. In the illustrated example, the name of the file for the aforementioned article data is described in the “ItemFile” element.

A “LayoutChange” element indicates whether or not the layout area for the article may be changed. In other words, this element shows whether or not the layout area for the article may be changed to an area other than the area defined in the “layout” element. An “ItemChange” element indicates whether the article may be replaced with another article. In both the elements, the value will be “OK” when change or replacement is allowed and “NG” when they are not allowed.

The manner of describing article data and layout data illustrated above is merely an example. Alternatively, NewsML (a format for news management based on XML) and/or other formats of description may be used.

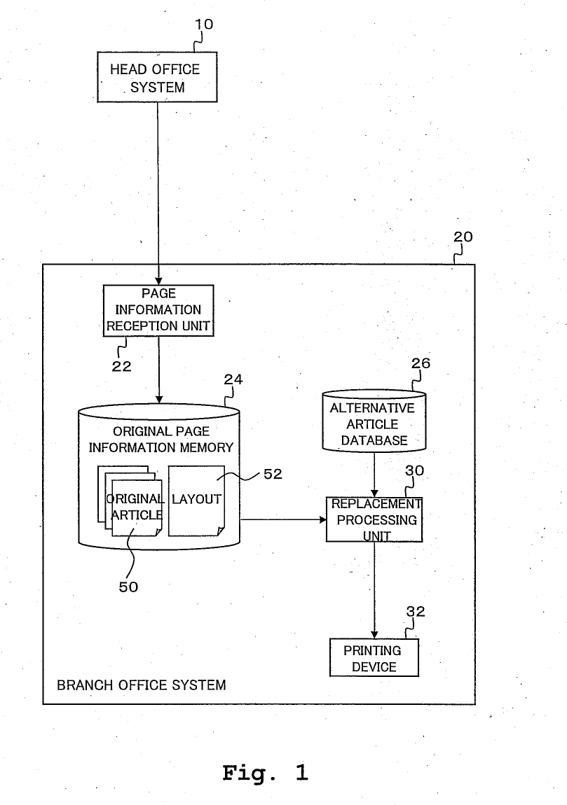

Referring again to FIG. 1, the head office system 10 transmits to the branch office system 20 newspaper page information including the article data 50 on each original article and the layout data 52, over the Internet or a data communication line such as a dedicated line.

In the branch office system 20, a page information reception unit 22 receives the newspaper page information and stores it in an original page information memory 24. The branch office system 20 is provided with an alternative article database 26. The alternative article database; 26 is a database storing candidate articles (which are called replacement candidate articles) which can replace articles contained in the newspaper pages transmitted from the head office system 10. An editor at the branch office may register in the alternative article database 26 a replacement candidate article the composed. The replacement candidate article may be an article or an advertisement specific to the region covered by the respective branch office. Data on a replacement candidate article have a format similar to the one illustrated in FIG. 2, but do not include the “LayoutChange” and “ItemChange” elements.

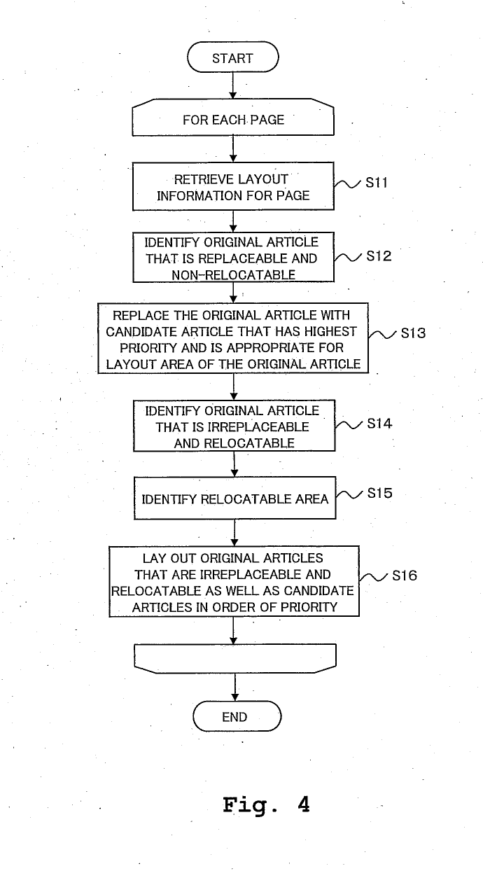

A replacement processing unit 30 performs processing for replacing with replacement candidate articles some articles in newspaper page data that are generated by the head office system 10 and stored in the original page information memory 24. The procedure of this processing is illustrated in FIG. 4.

This procedure is started when the user instructs replacement. In response to the instruction, the replacement processing unit 30 executes the processes from step S11 to S16 for each page. In processing for one page, the replacement processing unit 30 first retrieves from the layout data 52 stored in the original page information memory 24 layout information for the page (information in the “page” element that represents the page of interest in the example of FIG. 3) (S11). At this point, the replacement processing unit 30 identifies the category of the contents of the page by reference to the layout information retrieved. The category of the page contents can be identified by reference to the value of the “Category” element in the example shown, in FIG. 3.

The replacement processing unit 30 then checks the “LayoutChange” and “ItemChange” elements for each original article (i.e. “Item” element) within the page to identify any original article that is replaceable and non-relocatable (S12). If such an original article is found, the original article is replaced with a replacement candidate article. In this case, from among replacement candidate articles in the alternative article database 26 that are appropriate for the category of the contents of the page, there is selected a replacement candidate article that has high priority and is of a volume close to that of the original article (S13). This selection may use an evaluation function with the priority and the number of characters of an article as parameters. The evaluation function can be any function that outputs a higher score when a replacement candidate article has a higher priority and is of a volume closer to that of the original article.

The replacement processing unit 30 also identifies any original article that is irreplaceable and relocatable, by reference to “LayoutChange” and “ItemChange” elements of each original article in the page (S14). The replacements processing unit 30 further identifies any original article that is replaceable and relocatable, and determines as a relocatable area a collection of layout areas for relocatable articles, regardless of whether or not they are replaceable (S15).

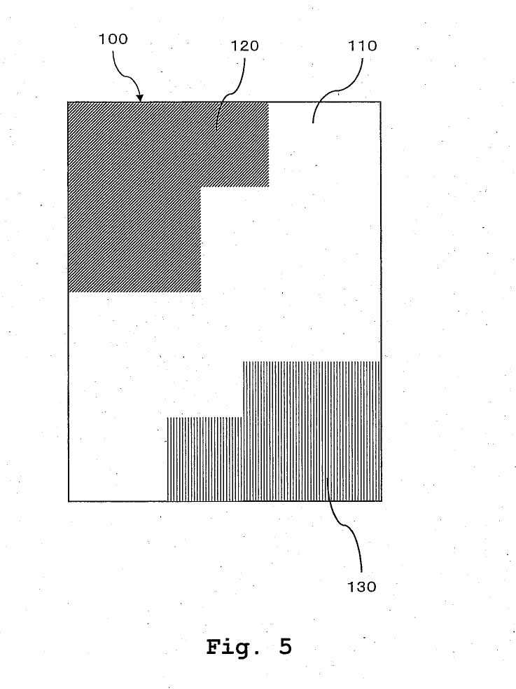

In the example shown in FIG. 5, for instance, an original article that is irreplaceable and non-relocatable is laid out without being replaced in a layout area specified in layout information. In a page space 100 of FIG. 5, a collection of layout areas for such original articles is shown as an area 110. A collection of layout areas for original articles that are replaceable and non-relocatable is indicated as an area 120. In the area 120, replacement candidate articles are laid out instead of original articles. A collection of layout areas for relocatable original articles is a relocatable area 130.

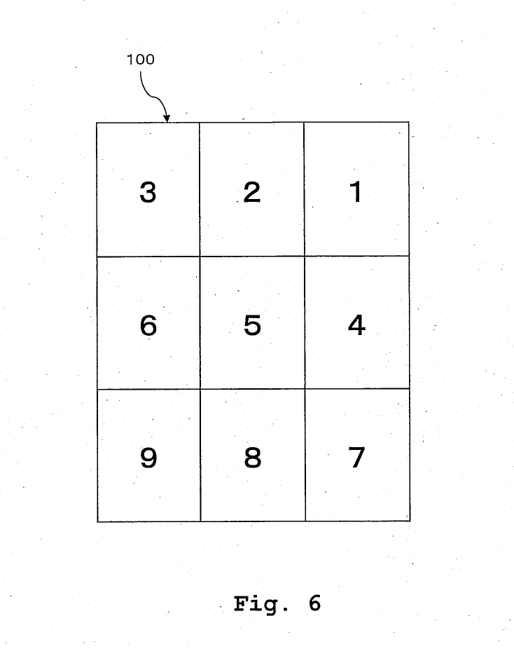

The replacement processing unit 30 arranges in this relocatable area original articles that are irreplaceable and relocatable, as well as replacement candidate articles. This arrangement is conducted such that it satisfies both a condition that any original article that is irreplaceable and relocatable on the page be arranged and a condition that an article of higher priority be laid out in an area of higher priority on the page. Partial areas within the page space; may be prioritized according to, for example, a rule that the upper right corner of the space has the highest priority and the priority lowers toward the lower left corner thereof in the order of raster scanning as shown in FIG. 6. This rule for prioritization is a mere example, of course.

In the arrangement process at step S16, original articles in the page that are irreplaceable and relocatable may be first arranged in descending order of priority starting from a partial area that has the highest priority within the page space. Then, replacement candidate articles appropriate for the category of the page may be arranged in descending order of priority in the remaining area that is, left after the arrangement of all the original articles. In this case, scores for various combinations of replacement candidate articles can be determined by means of an evaluation function that assigns a higher score for a replacement candidate article of higher priority to be arranged in the remaining area and a higher score when less blank would be left after arrangement, and a combination of replacement candidate articles that has the highest score may be arranged.

The procedure of arrangement process at step S16 illustrated above is merely an example. Alternatively, both original articles and replacement candidate articles may be randomly arranged and the result of the arrangement evaluated on the basis of an evaluation function to determine a layout that has the highest evaluation. The evaluation function used here may be a function that can generally judge, for the result of the arrangement, evaluation in terms of a condition that an article of higher priority be arranged in a partial area of higher priority in the page space, evaluation in terms of a condition that all the original articles that are irreplaceable and relocatable be arranged, and evaluation in terms of the amount of blank space that would be left in the final result of arrangement.

A newspaper page produced as the result of replacement which is automatically determined by the replacement processing unit 30 in the above manner may be displayed on a screen and the user at the branch office may be required to check whether or not the page is acceptable. If the user inputs a result, of evaluation to the effect that the page has some problem, the replacement processing unit 30 determines another replacement pattern.

In this procedure, the set of steps S12 and S13 and the set of steps S14 through S16 may be executed in any sequence or in parallel, as they are not mutually dependent.

When layout of the page space including article replacement is completed in such a manner, the replacement processing unit 30 feeds the articles into the page space in accordance with the layout to generate page image data of a predetermined file format; e.g., Portable Document Format (PDF). A printing device 32 prints the page image data onto paper sheets.

Although the illustrated example assumes the presence of an article that is replaceable and whose layout area cannot be changed, it is also possible to consider that any article that is replaceable always has a relocatable layout area. In this case, steps S12 and S13 will be unnecessary in the procedure of FIG. 4, and in step S15 a collection of layout areas for replaceable articles and relocatable articles may be determined as a relocatable area.

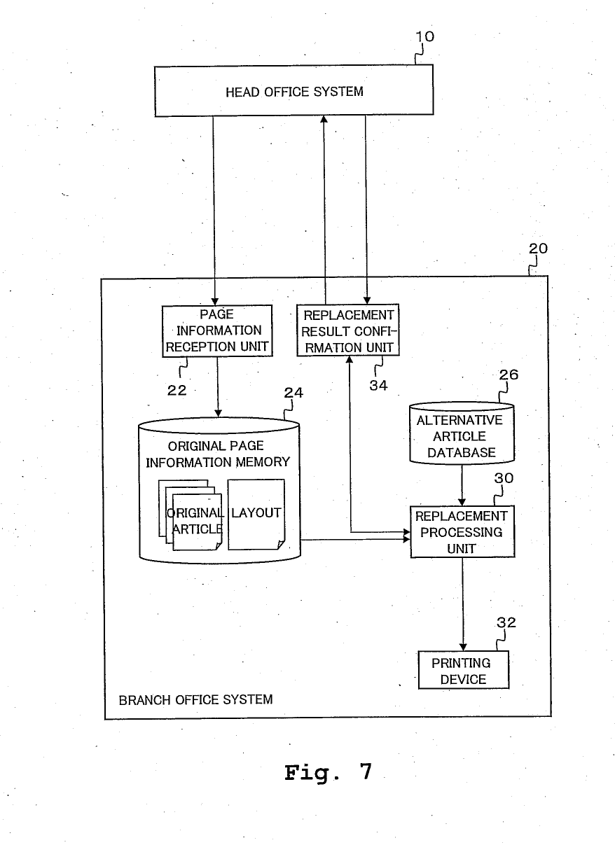

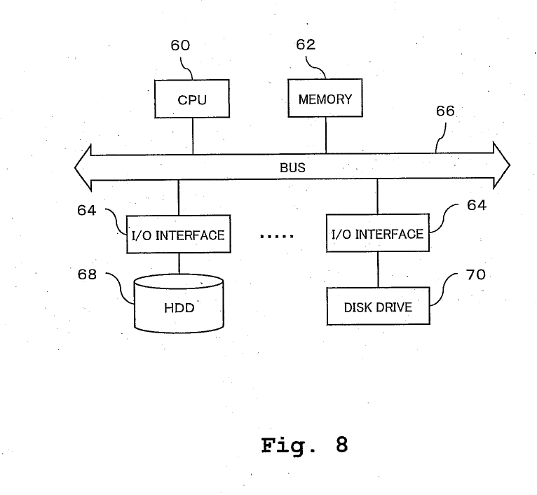

A variation will be now described with reference to FIG. 7. This variation is addition of a replacement result confirmation unit 34 to the exemplary embodiment illustrated in FIG. 1. The replacement result confirmation unit 34 performs processing for providing the head office with a newspaper page as a result of article replacement conducted by the replacement processing unit 30 and asking the head office for checking.

By way of example, the replacement result confirmation unit 34 receives from the replacement processing unit 30 page image data as the result of replacement, and attaches the page image data to an electronic mail message and sends the message to a reviewer at the head office. The e-mail address of the reviewer may be registered to the head office system 10 in advance. Here, the resolution of the page image data may be reduced before the data are attached to the e-mail message. In addition, the URL of a Web page for approval operation provided by the replacement result confirmation unit 34 is embedded in the e-mail message. If the reviewer at the head office checks the page image data attached to the e-mail message to find no problem with it, he can access the Web page for confirmation operation by using the URL and press a confirmation button on the Web page. The replacement processing unit 30 does not supply the page image data to the printing device 32 until the confirmation button is pressed. If the reviewer cannot approve the received page image, he can press a Not Accept button on the Web page. When the Not Accept button is pressed; that is, when the replacements result is not approved, the replacement processing unit 30 may indicate this on the display screen of the branch office system 200 and determine another replacement pattern.

Although in the above example page image data as the result of replacement are transmitted to the reviewer at the head office by electronic mail, the replacement result confirmation unit 34 may alternatively generate a Web page containing the page image data and a button for confirmation operation and transmit the URL of the Web page to the reviewer at the head office.

The units of the branch office system 20 illustrated above other than the printing device 32 are typically realized by a generic computer executing a program that describes the functions or processing of the units. The computer may have as hardware a circuit configuration in which a CPU (central processing unit) 60 such as a microprocessor, memory (primary storage) 62 such as random access memory, an I/O (input/output) interface 64 of various kinds and the like are interconnected by a bus 66. Connected to the bus, via the I/O interface 64, are, e.g., a hard-disk drive 68, a disk drive 70 for reading from or writing to a CD and/or a DVD, a device for reading from and writing to a portable non-volatile storage medium of various standards, such as flash memory, and so forth. The program describing the processing according to the exemplary embodiment is saved in a fixed storage device, such as the hard disk drive 68, and installed in the computer via a storage medium such as a CD and DVD or over a network. The program stored in the fixed storage device is read into the memory and executed by the CPU 60 so as to realize the processing according to the exemplary embodiment.

The foregoing description of the exemplary embodiments of the present invention has been provided for the purposes, of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An editing and printing system, comprising:
a layout information memory that stores layout information including information on a layout area for each original article on a page and information indicating whether or not each original article is replaceable;
a replacement candidate memory that stores replacement candidate articles;
a replaced version generation unit that generates a page of a replaced version by arranging a replacement candidate article stored in the replacement candidate memory in the layout area for an original article which is defined as replaceable in the layout information; and
a printing unit that prints the page of the replaced version generated by the replaced version generation unit.

2. The editing and printing system according to claim 1, wherein
the layout information stored in the layout information memory further includes information indicating whether or not the layout area of each the original article can be changed, and
the replaced version generation unit generates a page of the replaced version by laying out original articles that are defined as being relocatable and irreplaceable and one or more replacement candidate articles that are selected from the replacement candidate memory in a relocatable area which is a collection of layout areas for original articles that are defined as being relocatable.

3. The editing and printing system according to claim 2, further comprising
an order information memory that stores order information defining priority of each partial area on the page, wherein
the layout information stored in the layout information memory further includes information indicating the priority of each the original article,
the replacement candidate memory further stores information indicating the priority of each of the replacement candidate articles, and
the replaced version generation unit generates a page of the replaced version by arranging original articles that are defined as being relocatable and irreplaceable as well as the replacement candidate articles in descending order of priority starting from a partial area of higher priority in the relocatable area in accordance with the order information and under a condition that any original article that is defined as irreplaceable be arranged.

4. An editing system, comprising:
a layout information memory that stores layout information including information on a layout area of each original article on a page and information indicating whether or not each original article is replaceable;
a replacement candidate memory that stores replacement candidate articles; and
a replaced version generation unit that generates a page of a replaced version by arranging a replacement candidate article stored in the replacement candidate memory in the layout areas of an original article that is defined as replaceable in the layout information.

5. A computer-readable medium storing a program causing a computer to execute a process for producing a printed material, the process comprising:
storing layout information including information on a layout area for each original article on a page and information indicating whether or not each original article is replaceable in a layout information memory;
storing replacement candidate articles in a replacement candidate memory;
generating a page of a replaced version by arranging a stored replacement candidate article in the layout area for an original article which is defined as replaceable in the layout information; and
causing a printing unit to print the page of the replaced version generated.

6. The computer-readable medium according to claim 5, wherein
the layout information further includes information indicating whether or not the layout area of each the original article can be changed, and
the generation of a page of the replaced version comprises generating a page of the replaced version by laying out original articles that are defined as being relocatable and irreplaceable and one or more replacement candidate articles that are selected from the replacement candidate memory in a relocatable area which is a collection of layout areas for original articles that are defined as being relocatable.

7. The computer-readable medium according to claim 6, wherein
order information defining priority of each partial area on the page is stored in an order information memory, and
the layout information further includes information indicating the priority of each the original article,
the replacement candidate memory further stores information indicating the priority of each of the replacement candidate articles, and
the generation of a page of a replaced version comprises generating a page of the replaced version by arranging original; articles that are defined as being relocatable and irreplaceable as well as the replacement candidate articles in descending order of priority starting from a partial area of higher priority in the relocatable area in accordance with the order information and under a condition that any original article that is defined as irreplaceable be arranged.

8. A method for producing a printed material, comprising:
storing layout information including information on a layout area for each original article on a page and information indicating whether or not each original article is replaceable in a layout information memory;
storing replacement candidate articles in a replacement candidate memory;
generating a page of a replaced version by arranging a stored replacement candidate article in the layout area for an original article which is defined as replaceable in the layout information; and
causing a printing unit to print the page of the replaced version generated.
